(19) United States
(12) Patent Application Publication
(10) Pub. No.: US 2020/0201283 A1
(43) Pub. Date: Jun. 25, 2020

(54) NUMERICAL CONTROL DEVICE, NUMERICAL CONTROL MACHINE SYSTEM, MACHINING SIMULATION DEVICE, AND MACHINING SIMULATION METHOD

(71) Applicant: FANUC CORPORATION, Yamanashi (JP)

(72) Inventors: Nobuaki AIZAWA, Yamanashi (JP); Wei ZHAO, Yamanashi (JP)

(21) Appl. No.: 16/676,777

(22) Filed: Nov. 7, 2019

(30) Foreign Application Priority Data
Dec. 19, 2018 (JP) 2018-237096

(51) Int. Cl. G05B 19/4069; G05B 19/4063; G05B 19/4097; G05B 19/4155

(52) U.S. Cl. CPC G05B 19/4069; G05B 19/4063; G05B 2219/35471; G05B 19/4155; G05B 2219/34013; G05B 19/4097

(57) ABSTRACT

A numerical controller includes one or more of a first reversing point detecting unit that detects a reversing point in an axis direction of a machine based on a machining program, a second reversing point detecting unit that detects a reversing point in the axis direction based on a position command, a third reversing point detecting unit that detects a reversing point in the axis direction based on a positional deviation or position feedback information of a servo control unit that controls a servomotor which drives the axis, and a fourth reversing point detecting unit that detects a reversing point in the axis direction based on positional information of a movable portion of the machine, and a drawing unit that generates an image superimposing a reversing point location detected by the one or more reversing point detecting unit on an image of a workpiece.

This application is based on and claims the benefit of priority from Japanese Patent Application No. 2018-237096, filed on 19 Dec. 2018, the content of which is incorporated herein by reference.

### BACKGROUND OF THE INVENTION

### Field of the Invention

The present invention relates to a numerical control device, a numerical control machine system, a machining simulation device, and a machining simulation method, and more specifically, relates to a numerical control device, a machining simulation device, and a machining simulation method that control a machine such as a machining tool, a robot, and an industrial machine, and a servomotor that drives the shaft of the machine.

### Related Art

Conventionally, numerical control systems that use data analyzed by a machining simulation in actual machining have been known (for example, Japanese Unexamined Patent Application, Publication No. 2017-134505). Japanese Unexamined Patent Application, Publication No. 2017-134505 discloses a numerical control system including: a numerical controller that controls a machine based on a program; a machining simulation device that executes machining simulation processing of the program; and a machining information storage unit that stores machining information used when machining is performed based on the program, in which the machining simulation device includes: a setting data acquisition unit that acquires information necessary for the machining simulation processing of the program from the numerical controller; a program analysis unit that analyzes the program based on the information acquired by the setting data acquisition unit; a machining information acquisition unit that acquires machining information, which is information necessary for machining, from a result of the analysis by the program analysis unit; and a machining information storage unit that stores the machining information acquired by the machining information acquisition unit in the machining information storage unit, and the numerical controller includes: an analysis information acquisition unit that acquires the machining information from the machining information storage unit; and a reconstituting unit that reconstitutes information used for actual machining based on the machining information acquired by the analysis information acquisition unit.

Patent Document 1: Japanese Unexamined Patent Application, Publication No. 2017-134505

### SUMMARY OF THE INVENTION

In a case of machining a workpiece using a machine tool, a problem in machining such as striping on a machined surface of the workpiece may occur. Such a problem in machining is likely to occur at a reversing point location of the moving direction of a tool. Therefore, it is desirable to determine whether such a problem in machining is attributed to reversing point of the moving direction of a tool.

According to the first aspect of the present invention, a numerical control device (for example, a numerical control device 100 described later) according to one aspect of the present disclosure includes: a position command generating unit (for example, a position command generating unit 110 described later) that outputs a position command on the basis of a machining program; a servo control unit (for example, a servo control unit 120) that controls a servomotor (for example, a servomotor 200 described later) on the basis of the position command; at least one i detecting unit among a first reversing point detecting unit (for example, a reversing point detecting unit 131 described later) that detects reversing point in a direction of an axis of a machine (for example, a machine 300 described later) on the basis of the machining program, a second reversing point detecting unit (for example, a reversing point detecting unit 132) that detects reversing point in the direction of the axis on the basis of the position command generated by using the machining program, a third reversing point detecting unit (for example, a reversing point detecting unit 133) that detects reversing point in the direction of the axis on the basis of a positional deviation or position feedback information of the servo control unit that controls the servomotors which drives the axis, and a fourth reversing point detecting unit (for example, a reversing point detecting unit 134) that detects reversing point in the direction of the axis on the basis of positional information of a movable portion of the machine; a drawing unit (for example, a drawing unit 135 described later) that visualizes a reversing point location detected by the at least one reversing point detecting unit, and generates an image in which the reversing point location is superimposed on an image of a workpiece machined by the machine; and an output unit (for example, a display unit 136 described later) that outputs the image generated by the drawing unit.

According to the second aspect of the present invention, the numerical control device according to (1) above further includes at least two reversing point detecting units among the first reversing point detecting unit, the second reversing point detecting unit, the third detecting unit, and the fourth detecting unit, in which the drawing unit changes a display method for each of at least two reversing point locations detected by the at least two reversing point detecting unit to generate an image in which the reversing point locations are superimposed on the image of the workpiece.

According to the third aspect of the present invention, in the numerical control device according to (1) or (2) above, in which the output unit is a display unit that displays the image of the workpiece on which the reversing point location is visualized and superimposed.

According to the fourth aspect of the present invention, in the numerical control device according to any one of (1) to (3) above, the machine includes a plurality of axes, and the numerical control device further includes a manipulating unit (for example, a manipulating unit 137 described later) that visualizes the detected reversing point location, and designates, for each axis of the plurality of axes, whether to superimpose the reversing point location on the image of the workpiece.

According to the fifth aspect of the present invention, a numerical control machine system according to one aspect of the present disclosure is a numerical control machine system (for example, a numerical control machine system 10) including: a numerical control device according to any one of (1) to (4) above; a machine; and a servomotor that drives an axis of the machine.

According to the sixth aspect of the present invention, a machining simulation device according to one aspect of the present disclosure is a machining simulation device (for example, a machining simulation unit 130 described later) operated in a computer, and the machining simulation device includes: at least one reversing point detecting unit among: a first reversing point detecting unit (for example, a reversing point detecting unit 131) that detects reversing point in a direction of an axis of a machine (for example, a machine 300 described later) on the basis of the machining program, a second reversing point detecting unit (for example, a reversing point detecting unit 132) that detects reversing point in the direction of the axis on the basis of the position command generated by using the machining program, a third reversing point detecting unit (for example, a reversing point detecting unit 133) that detects reversing point in the direction of the axis on the basis of a positional deviation or position feedback information of a servo control unit (for example, servo control units 120, 20A described later) that controls a servomotor (for example, servomotor 200 described later) which drives the axis, and a fourth reversing point detecting unit (for example, a reversing point detecting unit 134) that detects reversing point in the direction of the axis on the basis of positional information of a movable portion of the machine (300); a drawing unit (for example, a drawing unit 135 described later) that visualizes a reversing point location detected by the at least one reversing point detecting unit, and generates an image in which the reversing point location is superimposed on an image of a workpiece machined by the machine; and an output unit (for example, a display unit 136 described later) that outputs the image generated by the drawing unit.

According to the seventh aspect of the present invention, a machining simulation method according to one aspect of the present disclosure is a machining simulation method including the steps of: performing at least one reversing point detection among: a first reversing point detection that detects reversing point in a direction of an axis of a machine (for example, a machine 300) on the basis of the machining program, a second reversing point detection that detects reversing point in the direction of the axis on the basis of the position command generated by using the machining program, a third reversing point detection that detects reversing point in the direction of the axis on the basis of a positional deviation or position feedback information of a servo control unit (for example, servomotors 120, 200A described later) that controls a servomotor (for example, a servomotor 200 described later) which drives the axis, and a fourth reversing point detection that detects reversing point in the direction of the axis on the basis of positional information of a movable portion of the machine; visualizing a reversing point location detected by the at least one reversing point detection, and generating an image in which the reversing point location is superimposed on an image of a workpiece machined by the machine; and outputting the image generated.

According to one aspect of the present disclosure, in a case in which a problem in machining such as striping on a machined surface of a workpiece occurs, it is possible to determine whether such a problem in machining is attributed to reversing point of the moving direction of a tool, or recognize a location at which there is a possibility of a problem in machining occurring.

### BRIEF DESCRIPTION OF THE DRAWINGS

FIG. 1 is a block diagram illustrating a configuration example of a numerical control machine system according to an embodiment of the present invention;

FIG. 2 is a block diagram illustrating a portion of a machine tool including a servomotor;

FIG. 3 illustrates a portion of machining programs;

FIG. 4 is a flowchart showing processing for detecting a reversing point location in a Z-axis direction in the machining programs;

FIG. 5 is a diagram illustrating a drawing of a workpiece displayed on a display unit in a case of not including a reversing point location;

FIG. 6 is a diagram illustrating a drawing of a workpiece displayed on the display unit in a case of including reversing point locations;

FIG. 7 is a diagram for describing tool tip point control; and

FIG. 8 is a diagram for describing overshoot in a case in which a machined shape is an arc shape.

### DETAILED DESCRIPTION OF THE INVENTION

In the following, the embodiment of the present invention will be described in detail using the drawings. It should be noted that, although reversing point in a Z-axis direction of a machine is exemplified in the embodiment described below, the present invention is not limited to reversing point in the Z-axis direction, and may be applied to reversing point in an X-axis direction, reversing point in a Y-axis direction, or the like.

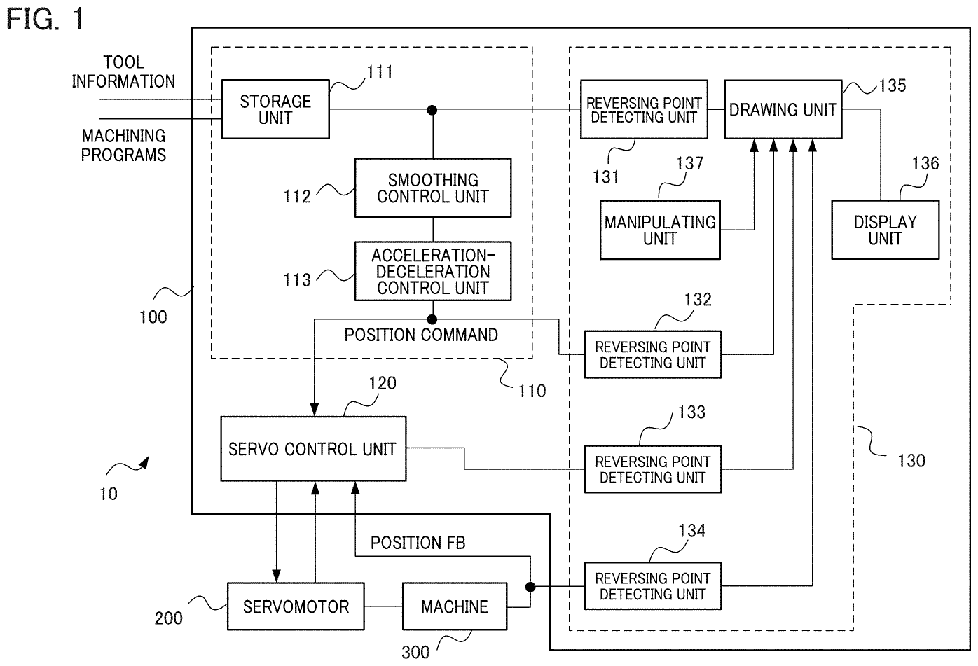

FIG. 1 is a block diagram illustrating a configuration example of a numerical control machine system according to an embodiment of the present invention. A numerical control machine system 10 (hereinafter, referred to as NC machine system) illustrated in FIG. 1 includes a numerical control device 100 (hereinafter, referred to as NC device), a servomotor 200, and a machine 300. The machine 300 may be, for example, a machine tool, a robot, or an industrial machine. In the descriptions provided below, examples of a machine tool will be given and described. The NC device 100 may be included in the machine 300. Furthermore, the servomotor 200 may be included in the machine 300. In a case in which the machine 300 includes the three axes of an X-axis, a Y-axis, and a Z-axis, for example, the servomotor 200 is provided to each of the axes.

The NC device 100 includes a position command generating unit 110, a servo control unit 120, and a machining simulation unit 130. The machining simulation unit 130 constitutes a machining simulation device. The position command generating unit 110 includes a storage unit 111, a smoothing control unit 112, and an acceleration-deceleration control unit 113. The storage unit 111 stores machining programs including command routes (arrangement of command points) indicating machining routes to be inputted and tool information to be inputted. The machining programs are outputted from CAM (Computer Aided Manufacturing). The machining programs and the tool information are read from the storage unit 111 and inputted to the smoothing control unit 112 on the basis of a machining execution instruction. The machining programs are outputted to a reversing point detecting unit 131 (described later). The smoothing control unit 112 performs smoothing control of a moving route based on a movement command indicated by the machining programs. Specifically, the smoothing control unit 112 corrects the movement command to be a smooth route, and thereafter interpolates points on the corrected moving route at an interpolation cycle (route correction). The acceleration-deceleration control unit 113 generates the movement command interpolated by the smoothing control unit 112, an acceleration-deceleration based on an acceleration-deceleration time constant, and a moving speed pattern based on the maximum speed, generates a position command based on the moving speed pattern, and outputs the position command to the servo control unit 120 and a reversing point detecting unit 132 (described later).

The servo control unit 120 calculates a positional deviation which is a difference between a position command to be inputted and a position detection value of position feedback information, generates a speed command by using the positional deviation, and further generates a torque command based on the speed command to output it to the servo motor 200. The positional deviation is outputted to a reversing point detecting unit 133 (described later). The servo motor 200 drives the Z-axis of the machine 300. With regard to the position feedback information, a position detection value from a linear scale attached to the machine 300 may be used. In FIG. 1, the position feedback information is outputted from the servo motor 200 and the machine 300 to the servo control unit 120. However, it suffices so long as any position feedback information is outputted to the servo control unit 120.

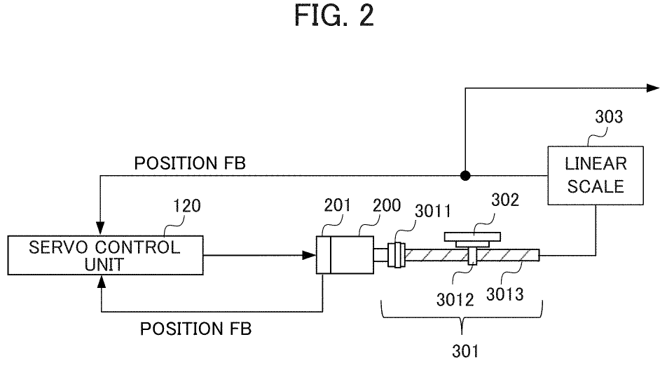

FIG. 2 is a block diagram illustrating a portion of the machine including the servo motor. The servo control unit 120 moves the table 302 by the servomotor 200 via a coupling mechanism 301, and machines a workpiece (a machined object) mounted on a table 302. The coupling mechanism 301 includes a coupling 3011 coupled to the servomotor 200 and a ball screw 3013 (provided as a movable portion) fixed to the coupling 3011, and a nut 3012 is threaded into the ball screw 3013. Owing to the rotary drive of the servomotor 200, the nut 3012 threaded into the ball screw 3013 moves in the axial direction of the ball screw 3013. The coupling mechanism 301 and the table 302 are portions of the machine 300.

The rotation angle position of the servomotor 200 is detected by a rotary encoder 201 as a position detecting unit that is associated with the servomotor 200, and the detected signal is subjected to integration and outputted to the servo control unit 120 as position feedback information (position FB) (referred to as “open loop control”). For the position feedback information, a position detection value derived from the linear scale 303 attached to an end of the ball screw 3013 of the machine 300 may be used (referred to as “closed loop control”). The linear scale 303 detects a moving distance of the ball screw 3013, outputs the output to the servo control unit 120 as the position feedback information, and further inputs the output to the reversing point detecting unit 134 as positional information of the ball screw 3013 as a movable portion of the machine 300.

The machining simulation unit 130 includes either of the reversing point detecting unit 131, the reversing point detecting unit 132, the reversing point detecting unit 133, and the reversing point detecting unit 134, the drawing unit 135, the display unit 136, and the manipulating unit 137. The machining simulation unit 130 can be provided outside the NC device 100 as a machining simulation device, and can be configured by an information processing device such as a personal computer (PC), a server, and the like. The reversing point detecting units 131 to 134 respectively correspond to a first reversing point detecting unit, a second reversing point detecting unit, a third reversing point detecting unit, and a fourth reversing point detecting unit. For the display unit 136, a liquid crystal display device, a printer, and the like can be used. The display unit 136 is an output unit that outputs an image of a workpiece (a machined object) on which a reversing point location is superimposed. The output unit may be a communication unit that transmits the image outside or a storage unit that stores the image. In the following descriptions, “either of the reversing point detecting unit 131, the reversing point detecting unit 132, the reversing point detecting unit 133, and the reversing point detecting unit 134” are simply referred to as “reversing point detecting units 131 to 134” unless otherwise described.

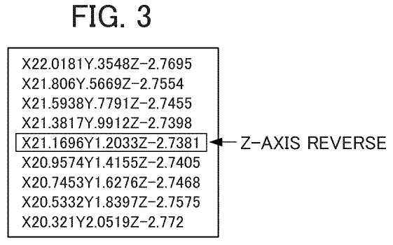

The reversing point detecting unit 131 detects a reversing point location in the Z-axis direction from, for example, the machining programs outputted from the storage unit 111. FIG. 3 illustrates a portion of the machining programs. FIG. 3 illustrates that the reversing point location in the Z-axis direction is “X21.1696Y1.2033Z-2.7381”. In FIG. 3, Y, and Z respectively represent the X-axis, the Y-axis, and the Z-axis, and the number following them represents the coordinate. It should be noted that, in FIG. 3, a portion of the machining programs is illustrated, and a single reversing point location is only illustrated. However, it is natural that a plurality of reversing point locations may exist.

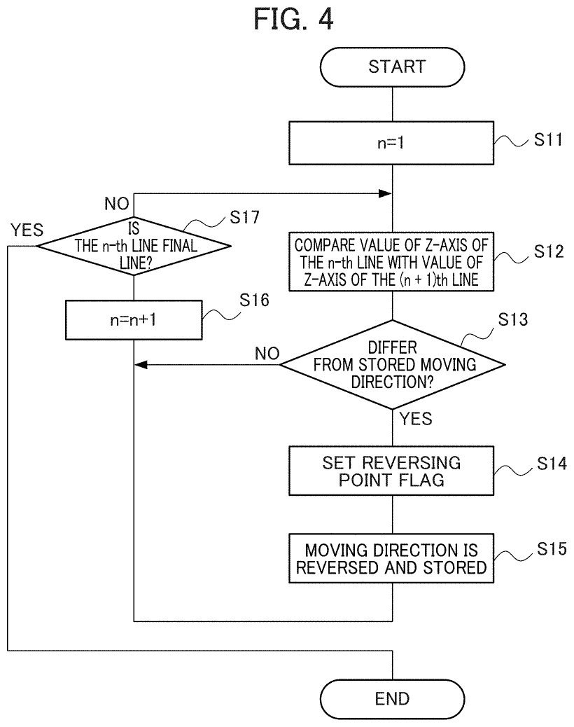

Processing for detecting the reversing point location in the Z-direction in the reversing point detecting unit 131 is described below with reference to FIG. 4. FIG. 4 is a flowchart showing processing for detecting the reversing point location in the Z-axis direction in the machining programs. In Step S11, a start line where a reversing point location detection in the Z-axis direction in the machining programs is started is set to the first line (n=1). In other words, when the number of the start line of the reversing point location detection is set as n (n is a natural number), it is set as n=1. It should be noted that the start line of the reversing point location detection may be set to a line other than the first line. In Step S12, a value of the Z-axis of the n-th line that has been set and a value of the Z-axis of the (n+1)th which is the next line are compared with each other to detect the moving direction. In a case of a value of the Z-axis of the (n+1)th>a value of the Z-axis of the n-th line, it is the positive moving direction. In a case of a value of the Z-axis of the (n+1)th=a value of the Z-axis of the n-th line, it is stop (zero moving direction). In a case of a value of the Z-axis of the (n+1)th<a value of the Z-axis of the n-th line, it is the negative moving direction.

In Step S13, it is determined whether the moving direction detected in Step S12 is different from a recorded moving direction. The moving direction of the Z-axis of the n-th previous line is stored in the storage unit, and for example, the positive moving direction or the negative moving direction is stored as the moving direction of the Z-axis. The moving direction of the Z-axis of the n-th previous line is the recorded moving direction. In a case in which it is determined in Step S13 that the moving direction detected in Step S12 is different from the recorded moving direction, in Step S14, a reversing point flag indicating that the moving direction is reversed is set to the n-th line, and the resulting moving direction is stored (recorded) in the storage unit. Here, the difference in the moving direction refers to the relationship between the positive moving direction and the negative moving direction. It should be note that, in Step S13, in a case of n=1, there is no moving direction of the Z-axis of the previous n-th line, and there is no recorded moving direction. Therefore, the processing advances to Step S16.

In Step S15, the recorded moving direction is reversed, and the resulting moving direction is stored. Then, the processing advances to Step S16. More specifically, in a case in which the moving direction of the Z-axis of the previous n-th line is the positive direction, it is stored as the negative direction. In a case in which the moving direction of the Z-axis of the previous n-th line is the negative direction, it is stored as the positive direction. Furthermore, a value of the Z-axis of the n-th line is stored as a reversing point location in the storage unit.

In Step S13, in a case in which the detected moving direction is not different from the recorded moving direction, it advances to Step S16. In Step S13, in a case in which the detected moving direction is stop, the direction is not reversed. Therefore, the processing returns to Step S16.

In Step S16, a new n value by adding 1 to n (n=n+1) is set.

In Step S17, it is determined whether the n-th line is the final line in the machining programs. In a case in which the n-th line is the final line in the machining programs, the detection processing of the reversing point location in the Z-axis direction ends. In a case in which the n-th line is not the final line in the machining programs, the processing returns to Step S12, and performs the processing from Step S12 to Step S17. By the repetition of the processing from Step S12 to Step S17, for the reversing point location in the Z-axis direction of the machining programs, a line number, a reversing point flag, and a value of an axis are stored in the storage unit. By the reversing point detection processing in the Z-axis direction in the reversing point detecting unit 131 as described above, it is possible to obtain a reversing point location in the Z-axis direction on the basis of a command route defined by the machining programs.

The drawing unit 135 visualizes a reversing point location detected from the machining programs in the reversing point detecting unit 131, superimposes the reversing point location on an image of a workpiece (a machined object), generates image information indicating that the reversing point location is shown on the workpiece (referred to as a first image information), and transmits the resulting information to the display unit 136. Here, visualizing the reversing point location refers to processing of allowing for the identification through an image and a vision of the workpiece, and more specifically, refers to changing a display method such as a display color, a line width, and a pattern of a line (solid line, dash line, long dashed short dashed line, etc.) in the image of the workpiece. The drawing unit 135 can generate drawing information in which a command route point including a visualized reversing point location is plotted (image information of a two-dimensional workpiece), or can generate image information of a workpiece on which a reversing point location visualized by using a three-dimensional solid model is superimposed. It should be noted that, as described later, the drawing unit 135 visualizes the reversing point locations detected by the reversing point detecting unit 132, the reversing point detecting unit 133, and the reversing point detecting unit 134 (described later), superimposes the reversing point locations on the respective images of the workpieces, generates pieces of image information each indicating that the reversing point location is shown on the workpiece (i.e., second image information, third image information, and fourth image information), and transmits the resulting information to the display unit 136.

The manipulating unit 137 designates, to the drawing unit 135, image information transmitted from the drawing unit 135 to the display unit 136 on the basis of selection information inputted by a user. The drawing unit 135 selects one among the first image information, the second image information, the third image information, and the fourth image information on the basis of the designation from the manipulating unit 137, and transmits the selected one to the display unit 136. The display unit 136 displays the image information generated by the drawing unit 135. As described above, in a case in which the machine 300 includes a plurality of axes (for example, the three axes, which are the X axis, the Y axis, and the Z axis), the servomotor 200 is provided to each of the axes. In this case, on the basis of the selection information of the axis by the user, the manipulating unit 137 may visualize the detected reversing point location, and instruct the drawing unit 135 to select, for each axis of the machine 300, whether to superimpose the reversing point location on an image of a workpiece (a machined object), and transmit the resulting information to the display unit 136.

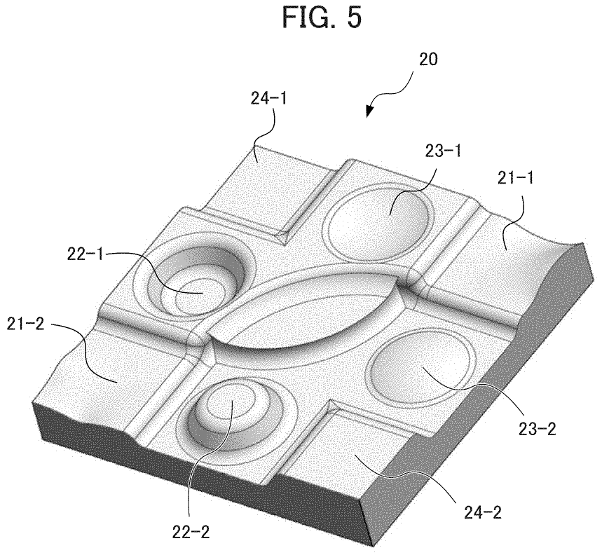

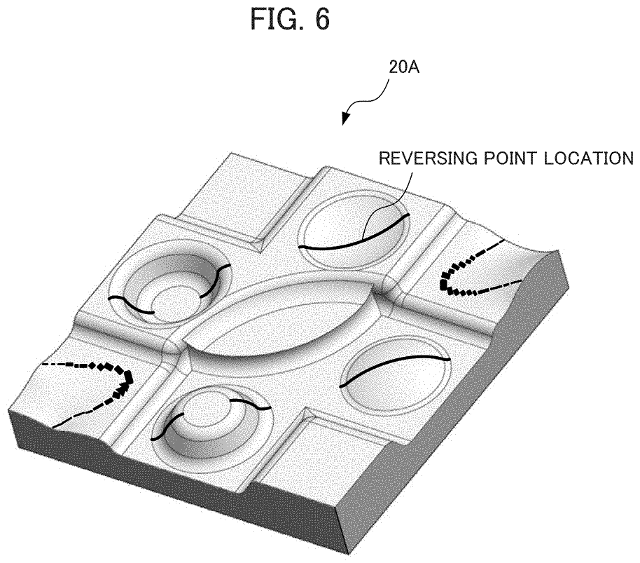

FIG. 5 is a diagram illustrating a drawing of a workpiece displayed on a display unit in a case of not including a reversing point location. FIG. 6 is a diagram illustrating a drawing of a workpiece displayed on a display unit in a case of including a reversing point location. FIG. 5 and FIG. 6 are each a diagram illustrating a drawing using the three-dimensional solid mode. A workpiece 20 on a display screen of the display unit 136 illustrated in FIG. 5 includes an inclined portion 21-1, an inclined portion 21-2 having the inverse shape of the inclined portion 21-1, a circular hole portion 22-1, a circular protruding portion 22-2 having the inverse shape of the circular hole portion 22-1, a concave surface 23-1 having an arc-shaped cross section, a circular convex surface 23-2 having the inverse shape of the concave surface 23-1, a rectangle groove 24-1, and a rectangle protruding portion 24-2 having the inverse shape of the rectangular groove 24-1.

A workpiece 20A on the display screen of the display unit 136 illustrated in FIG. 6 is an image of a workpiece in which reversing point locations are superimposed on the image of the workpiece 20 illustrated in FIG. 5. In a case in which the difference to height in adjacent tool routes becomes regularly even due to reciprocating machining by a tool, striping occurs, and can be recognized by the naked eye. In a case in which striping actually occurred on a workpiece machined by the machine 300 on the basis of the machining programs, a user observes whether the striping occurred on the machined workpiece coincide with the lines of the reversing point locations (illustrated in FIG. 6) in the Z-axis direction detected by the reversing point detecting unit 131. In a case in which the striping on the machined workpiece coincides with the lines of the reversing point locations in the Z-axis direction illustrated in FIG. 6, it is found that the striping generated due to reversing point of the Z-axis direction in the command routes defined by the machining programs. In a case in which the striping on the machined workpiece does not coincide with the lines of the reversing point locations in the Z-axis direction illustrated in FIG. 6, it is found that striping generated due to a factor other than the reversing point of the Z-axis direction in the command routes defined by the machining programs. As described above, by using the reversing point detecting unit 131, it is possible to determine whether the factor of machining failure on a workpiece (the formation of striping) is based on a reversing point in a command route defined by machining programs.

Next, the processing for detecting the reversing point location in the Z-axis direction in the reversing point detecting unit 132 is described. The processing for detecting the reversing point location in the Z-axis direction in the reversing point detecting unit 132 is performed similarly to the processing of the flowchart shown in FIG. 4, except for detecting the moving direction on the basis of the change (increase, decrease, or maintaining) of a position command generated by the position command generating unit 110 in place of detecting the moving direction by comparing a value of the Z-axis of the n-th line of the machining programs with a value of the Z-axis of the (n+1)th line of the machining programs.

The reversing point detecting unit 132 detects the revers ng point location in the Z-axis direction based on a position command outputted from the acceleration-deceleration control unit 113. The drawing unit 135 visualizes the revers ng point location detected by the reversing point detecting unit 132, superimposes the resulting reversing point location on an image of a workpiece, and generates image information indicating that the reversing point location is shown on the workpiece, and the display unit 136 displays the image information generated by the drawing unit 135.

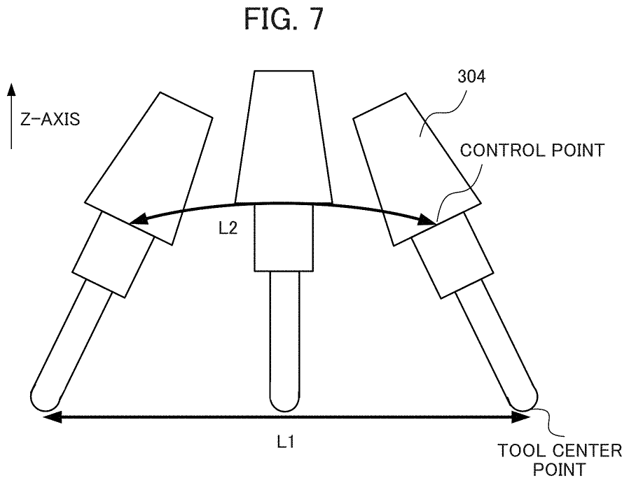

In a case in which striping are actually generated on a workpiece machined by the machine 300 on the basis of the machining programs, a user observes whether the striping on the machined workpiece coincides with the lines of the reversing point locations in the Z-axis direction detected by the reversing point detecting unit 132. In a case in which the striping on the machined workpiece coincides with the lines of the reversing point locations in the Z-axis direction, it is found that the striping generated due to the reversing point of the Z-axis direction in the position command generated by the position command generating unit 110. In a case in which the striping on the machined workpiece does not coincide with the lines of the reversing point locations in the Z-axis direction, it is found that the striping generated due to a factor other than the reversing point of the Z-axis direction by the position command generating unit 110. In the machining programs, generating the movement command for each axis is common; however, since in the simultaneous 5-axis machining, two rotation axes are added to three straight axes, it is required to consider the moving amount of control points of a machine structure and a tool length. With regard to the machining programs of the 5-axis machine tool, by commanding the tip position of the tool and the inclination of the tool with respect to a workpiece, the route of the tip point of a tool 304 is commanded as indicated by a route L1 by way of the tool tip point control illustrated in FIG. 7. On the other hand, the position command generating unit 110 calculates the control point for each axis in consideration of the tool and the machine structure so as to satisfy both the tip position of the tool and the inclination of the tool with respect to the workpiece. For example, as indicated by a route L2 illustrated in FIG. 7, the position command generating unit 110 calculates the arc-shaped route L2 in the Z-axis direction of the control point of the tool 304. Since it is not possible to detect the reversing point location in the Z-axis direction of such a route L2 even by analyzing the machine programs, the reversing point detecting unit 132 detects the reversing point location in the Z-axis direction in the route L2 on the basis of the position command. As described above, by using the reversing point detecting unit 132, it is possible to determine whether the factor of machining failure on a workpiece (the formation of striping) is based on a reversing point in the Z-axis direction in the position command.

Next, the processing for detecting the reversing point location in the Z-axis direction in the reversing point detecting unit 133 is described. The processing for detecting the reversing point location in the Z-axis direction in the reversing point detecting unit 133 is performed similarly to the processing of the flowchart shown in FIG. 4, except for detecting the moving direction on the basis of the change (increase, decrease, or maintaining) of a positional deviation (the difference between a position command and position feedback information) in place of detecting the moving direction by comparing a value of the Z-axis of the n-th line of the machining program with a value of the Z-axis of the (n+1)th line of the machining program. The reversing point detecting unit 133 detects the reversing point location in the Z-axis direction, for example, based on a positional deviation outputted from the servo control unit 120. When the servomotor 200 positions a tool of the machine 300 at a target position of the Z-axis, an overshoot may be generated due to the characteristics of the servo control unit 120. Due to this overshoot, a reversing point in the Z-axis direction is generated in order to return to the target position from the position that has gone beyond the target position of the Z-axis. The reversing point generated due to the overshoot is based on the characteristics of feed forward control, etc., of the servo control unit 120, and thus, is not based on the command route defined by the machining programs or the position command generated by the position command generating unit 110. By detecting the reversing point location in the Z-axis direction from the positional deviation, it is possible for the reversing point detecting unit 133 to detect the reversing point generated due to an overshoot, etc., for example.

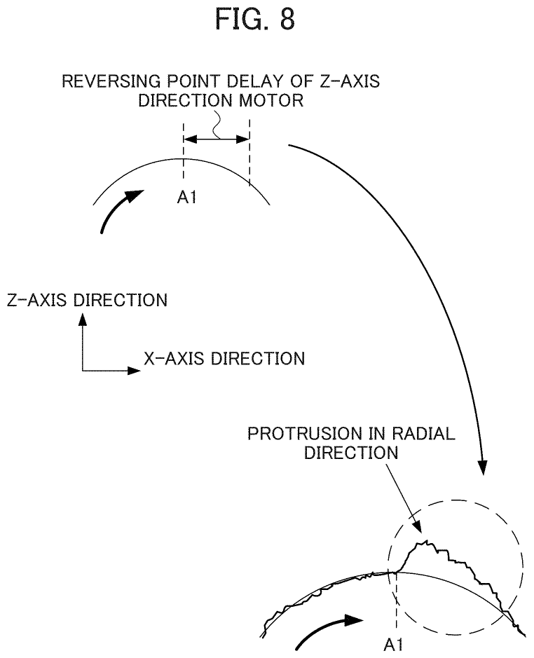

More specifically, in a case in which the machining shape is an arc shape, as illustrated in FIG. 8, for the servomotor 200 that moves a tool in the Z-axis direction, the rotational direction reverses at a position A1, and a servomotor that moves a tool in the X-axis direction rotates in a constant direction at substantially a constant speed in the proximity of the position A1. At this time, in a case in which an overshoot is generated when the rotational direction of the servomotor that moves the tool in the Z-axis direction is tried to be reversed at the position A1, a protrusion is generated in the radial direction. Since the positional deviation increases, and then, decreases at the portion of this protrusion, it is possible for the reversing point detecting unit 133 to detect the reversing point location in the Z-axis direction.

The drawing unit 135 visualizes the reversing point location detected by the reversing point detecting unit 133, superimposes the resulting reversing point location on an image of workpiece (a machined object), and generates image information indicating that the reversing point location is shown on the workpiece, and the display unit 136 displays the image information generated by the drawing unit 135.

In a case in which striping actually generated on a workpiece machined by the machine 300 on the basis of the machining programs, a user observes whether the striping on the machined workpiece coincides with the lines of the reversing point locations in the Z-axis direction detected by the reversing point detecting unit 133. In a case in which the striping on the machined workpiece coincides with the lines of the reversing point locations in the Z-axis direction, it is found that the striping generated due to the reversing point in the Z-axis direction by the control of the servo control unit 120. In a case in which the striping on the machined workpiece does not coincide with the lines of the reversing point locations in the Z-axis direction, it is found that the striping generated due to a factor other than the reversing point in the Z-axis direction by the control of the servo control unit 120.

It should be noted that the reversing point location in the Z-axis direction has been detected here by using position feedback information (position detection value) which is obtained by integrating the output of the rotary encoder 201 attached to the servo motor 200 illustrated in FIG. 2. As described above, by using the reversing point detecting unit 133 in the open loop control system, it is possible to determine whether the factor of machining failure on a workpiece (the formation of striping) is based on the reversing point generated by the overshoot, etc., due to the characteristics such as feed forward control, etc.

Next, the processing for detecting the reversing point location in the Z-axis direction in the reversing point detecting unit 134 is described. The processing for detecting the reversing point location in the Z-axis direction in the reversing point detecting unit 134 is performed similarly to the processing of the flowchart shown in FIG. 4, except for detecting the moving direction on the basis of the change (increase, decrease, or maintaining) of a positional information (position detection value) from the linear scale 303 in place of detecting the moving direction by comparing a value of the Z-axis of the n-th line of the machining program with a value of the Z-axis of the (n+1)th line of the machining program. The signal of the positional information outputted from the linear scale 303 is the same as the signal of the position feedback information outputted from the linear scale 303. In a case of positioning at a target position of the Z-axis, overshoot may occur due to the deterioration of a ball screw, backlash, or the like. Due to this overshoot, a reversing point is generated in order to return to the target position from the position that has gone beyond the target position of the Z-axis. In a case in which the reversing point generated due to this overshoot is attributed to the characteristics of the machine 300 such as the deterioration of a ball screw, backlash, or the like, the detection is not possible by way of the machining programs or the position command. Furthermore, the detection may not be possible by way of the open loop control system. The reversing point detecting unit 134 detects the reversing point location in the Z-axis direction by using the positional information of the linear scale 303 attached to the machine 300. The servo control unit 120 may use the positional information that is calculated from the linear scale 303 attached to the machine 300 as the position feedback information.

Similarly to the overshoot due to the characteristics of the servo control unit 120, when the overshoot due to the characteristics of the machine 300 such as the deterioration of a ball screw, backlash, or the like, occurs, a protrusion is generated in a radial direction, as illustrated in FIG. 8. Since the positional deviation increases, and then, decreases at the portion of this protrusion, it is possible for the reversing point detecting unit 134 to detect the reversing point location in the Z-axis direction.

The drawing unit 135 visualizes the reversing point location detected by the reversing point detecting unit 134, superimposes the resulting reversing point location on an image of a workpiece, and generates image information indicating that the reversing point location is shown on the workpiece, and the display unit 136 displays the image information generated by the drawing unit 135.

In a case in which striping actually occurred on a workpiece machined by the machine 300 on the basis of the machining programs, a user observes whether the striping on the machined workpiece coincides with the lines of the reversing point locations in the Z-axis direction detected by the reversing point detecting unit 134. In a case in which the striping on the machined workpiece coincides with the lines of the reversing point locations in the Z-axis direction, it is found that the striping generated due to the reversing point in the Z-axis direction by the drive of the machine 300. In a case in which the striping on the machined workpiece does not coincide with the lines of the reversing point locations in the Z-axis direction, it is found that the striping generated due to a factor other than the reversing point in the Z-axis direction by the drive of the machine 300. As described above, by using the reversing point detecting unit 134 in the closed loop control system, it is possible to determine whether the factor of machining failure on a workpiece (the formation of a stripe-like line) is based on the reversing point in the Z-axis direction by the drive of the machine 300.

In the descriptions above, the manipulating unit 137 designates, to the drawing unit 135, one from among the pieces of image information (one from among the first image information, the second image information, the third image information, and the fourth image information) transmitted from the drawing unit 135 to the display unit 136 on the basis of the selection information inputted by the user. Thereafter, by comparing the striping on the machined workpiece by the machine 300 with the lines of the reversing point locations in the Z-axis direction detected by either of the reversing point detecting units 131 to 134, the factor of the generation of machining failure on a workpiece has been determined.

However, it is possible to determine the factor of the generation by visualizing at least two reversing point locations in the Z-axis direction detected by at least two reversing point detecting units among the reversing point detecting units 131 to 134, superimposing the resulting reversing point locations on the workpiece illustrated in FIG. 5, displaying the resulting information on the display unit 136, and comparing such information with the striping on the machined workpiece by the machine 300. In such a case, it is preferable to perform display by changing a display method such as a display color, a line width, and a pattern of a line (solid line, dash line) for each reversing point location of the at least two reversing point locations. For example, by performing display by superimposing lines of three reversing point locations in the Z-axis direction detected by the reversing point detecting unit 131, the reversing point detecting unit 132, and the reversing point detecting unit 133 on the workpiece with red color, blue color, and green color, respectively, it is possible to compare the lines of the three reversing point locations in the Z-axis direction with the striping on the machined workpiece by the machine 300, and it is possible to determine where the factor of the generation of the striping exists among the machining programs, the NC device, and the servo control device, by determining which striping on the machined workpiece by the machine 300 coincides with which line of the three reversing point locations. It should be noted that the machining simulation unit 130 illustrated in FIG. 1 may not include all of the reversing point detecting units 131 to 134, and it suffices so long as the machining simulation unit 130 includes at least one reversing point detecting unit among the reversing point detecting unit 131, the reversing point detecting unit 132, the reversing point detecting unit 133, and the reversing point detecting unit 134.

### (Modified Example)

In the embodiment described above, regarding the NC machine system 10, an example in which the NC device 100 includes the serve control unit 120 and the machining simulation unit 130 is described. However, a portion of the servo control unit 120 and/or the machining simulation unit 130 may be provided outside the NC device. In a case in which a portion of the servo control unit 120 and the machining simulation unit 130 is provided outside the NC device, the reversing point detecting unit 133 as the third reversing point detecting unit may be provided in the servo control unit 120, and the reversing point detecting unit 134 may be provided outside the NC device 100.

According to the embodiment, etc., described above, in a case in which a problem in machining such as a striping on a machined surface of a workpiece occurs, it is possible to determine whether such a problem in machining is attributed to a reversing point in a moving direction of a tool, or determine a possibility of a problem in machining occurring. Furthermore, the reversing point location of the moving direction of a tool is influenced by the machining programs, the position command generating unit, the servo control unit, and the machine. However, according to the present embodiment, in a case in which a problem in machining such as striping on a machined surface of a workpiece occurs, it is possible to specify where the factor of the generation is caused among the machining programs, the position command generating unit, the servo control unit, and the machine. Furthermore, even before machining by the machine, it is possible to recognize a location at which there is a possibility of a problem in machining due to the reversing point in the moving direction of a tool occurring.

The embodiment, etc., according to the present invention has been described above. However, each constituting part such as the NC device, the position command generating unit 110 included in the NC device, the servo control unit 120, the machining simulation unit, etc., described above can be realized by hardware, software, or a combination thereof. Furthermore, the machining simulation method performed in cooperation with each of the abovementioned constituting parts can also be realized by hardware, software, or a combination thereof. Here, the matter of being realized by software indicates that a processor reads and executes programs.

These programs can be stored using various types of non-transitory computer readable media, and provided to a computer. The non-transitory computer readable media includes various types of tangible storage media. Examples of the non-transitory computer readable media include magnetic recording media (for example, flexible disk, hard disk drive), magneto-optical recording media (for example, magneto-optical disk), CD-ROM (Read Only Memory), CD-R, CD-R/W, and semiconductor memory (for example, mask ROM, PROM (Programmable ROM), EPROM (Erasable PROM), flash ROM, and RAM (random access memory)).

In order to realize the functional blocks included in the NC device 100, the position command generating unit 110, the servo control unit 120, and the machining simulation unit illustrated in FIG. 1 (referred to as the NC device 100, etc.), the NC device 100, etc. are configured by a computer including an arithmetic processing unit such as a CPU (Central Processing Unit), etc. Furthermore, the NC device 100, etc. include an auxiliary storage device such as HDD (Hard Disk Drive) storing programs for various types of control such as application software and OS (Operating System), and a main memory unit such as RAM (Random Access Memory) for storing temporarily required data upon the arithmetic processing unit executing programs.

Thereafter, in the NC device 100, etc., the arithmetic processing based on the application software or the OS is performed while the arithmetic processing unit reads the application software or the OS from the auxiliary storage device, and expands, in the main memory unit, the application software or the OS that has been read. Furthermore, a variety of kinds of pieces of hardware included in the NC device are controlled based on a result of the arithmetic processing. This allows the functional blocks of the present embodiment to be realized. In other words, the present embodiment can be realized by the cooperation of hardware and software.

The abovementioned embodiment is a preferable embodiment of the present invention; however, the scope of the present invention is not limited to only the abovementioned embodiment, and implementation is possible by an embodiment to which. modifications were made in various ways within a scope not departing from the spirit of the present invention. For example, the machine tool has been described as an example of a machine. However, it can be applied to a robot and an industrial machine. In a case in which an arm of the robot performs coating or welding in a reciprocal movement accompanied with reversing point in the axial direction, it is possible to apply the numerical control device, the numerical control machine system, the machining simulation device, and the machining simulation method of the present embodiment thereto.

### EXPLANATION OF REFERENCE NUMERALS

10, 10A NC machine system
100 NC device
110 position command generating unit
120 servo control unit
130 machining simulation unit
131 to 134 reversing point detecting unit
135 drawing unit
136 display unit
137 manipulating unit
200 servomotor
300 machine

What is claimed is:

1. A numerical control device comprising:
a position command generating unit that outputs a position command on the basis of a machining program;
a servo control unit that controls a servomotor on the basis of the position command;
at least one reversing point detecting unit among
a first reversing point detecting unit that detects reversing point in a direction of an axis of a machine on the basis of the machining program,
a second reversing point detecting unit that detects reversing point in the direction of the axis on the basis of the position command generated by using the machining program,
a third reversing point detecting unit that detects reversing point in the direction of the axis on the basis of a positional deviation or position feedback information of the servo control unit that controls the servomotor which drives the axis, and
a fourth reversing point detecting unit that detects reversing point in the direction of the axis on the basis of positional information of a movable portion of the machine;
a drawing unit that visualizes a reversing point location detected by the at least one reversing point detecting unit, and generates an image in which the reversing point location is superimposed on an image of a workpiece machined by the machine; and
an output unit that outputs the image generated by the drawing unit.

2. The numerical control device according to claim 1, further comprising:
at least two reversing point detecting units among the first reversing point detecting unit, the second reversing point detecting unit, the third detecting unit, and the fourth detecting unit,
wherein the drawing unit changes a display method for each of at least two reversing point locations detected by the at least two reversing point detecting unit to generate an image is which the reversing point locations are superimposed on the image of the workpiece.

3. The numerical control device according to claim 1, wherein the output unit is a display unit that displays the image of the workpiece, wherein the reversing point location is visualized and superimposed on the image of the workpiece.

4. The numerical control device according to claim 1, wherein
the machine includes a plurality of axes, and
the numerical control device further comprises a manipulating unit that visualizes the detected reversing point location, and designates, for each axis of the plurality of axes, whether to superimpose the reversing point location on the image of the workpiece.

5. A numerical control machine system comprising:
a numerical control device according to claim 1;
a machine; and
a servomotor that drives an axis of the machine.

6. A machining simulation device operated in a computer, the machining simulation device comprising:
at least one reversing point detecting unit among:
a first reversing point detecting unit that detects reversing point in a direction of an axis of a machine on the basis of the machining program,
a second reversing point detecting unit that detects reversing point in the direction of the axis on the basis of the position command generated by using the machining program,
a third reversing point detecting unit that detects reversing point in the direction of the axis on the basis of positional deviation or position feedback information of a servo control unit that controls a servomotor which drives the axis, and
a fourth reversing point detecting unit that detects reversing point in the direction of the axis on the basis of positional information of a movable portion of the machine;
a drawing unit that visualizes a reversing point location detected by the at least one reversing point detecting unit, and generates an image in which the reversing point location is superimposed on an image of a workpiece machined by the machine; and
an output unit that outputs the image generated by the drawing unit.

7. A machining simulation method comprising the steps of:
performing at least one reversing point detection among:
a first reversing point detection that detects reversing point in a direction of an axis of a machine on the basis of the machining program,
a second reversing point detection that detects reversing point in the direction of the axis on the basis of the position command generated by using the machining program,
a third reversing point detection that detects reversing point in the direction of the axis on the basis of a positional deviation or position feedback information of a servo control unit that controls a servomotor which drives the axis, and
a fourth reversing point detection that detects reversing point in the direction of the axis on the basis of positional information of a movable portion of the machine;
visualizing a reversing point location detected by the at least one reversing point detection, and generating an image in which the reversing point location is superimposed on an image of a workpiece machined by the machine; and
outputting the image generated.
